(19) United States
(12) Patent Application Publication
(10) Pub. No.: US 2013/0335674 A1
(43) Pub. Date: Dec. 19, 2013

(54) Backlight Module and Liquid Crystal Display Device

(71) Applicants: Che-chang Hu, Shenzhen (CN); Hu He, Shenzhen (CN)

(72) Inventors: Che-chang Hu, Shenzhen (CN); Hu He, Shenzhen (CN)

(73) Assignee: SHENZHEN CHINA STAR OPTOELECTRONICS TECHNOLOGY CO. LTD., Shenzhen (CN)

(21) Appl. No.: 13/581,314

(22) PCT Filed: Jun. 20, 2012
(86) PCT No.: PCT/CN12/77201

§ 371 Date: Aug. 26, 2012

(30) Foreign Application Priority Data
Jun. 13, 2012 (CN) 201210194335.2

(51) Int. Cl. F21V 8/00

(52) U.S. Cl. CPC G02B 6/0013
USPC 349/64; 362/606; 349/65

(57) ABSTRACT

The present invention provides a backlight module and a LCD device. The backlight module comprises a light guide plate comprising a incident surface and a emitting surface connecting with the incident surface, a light bar, set up on the side of the incident surface, arranging a plurality of LEDs at intervals at the side close to the incident surface, an optical film, set up on side of the emitting surface, having a plurality of notches at the side close to the light bar, wherein each of the plurality of notches corresponds to each of the plurality of LCD light sources. The present invention prevents the optical film from light-gathering the area in front of the LED by using the optical film in the shape of the arrangement of the LED to improve a mura problem of the incident side of the backlight module and solve the problem of light leakage of the backlight module in a design of a narrow plastic frame to boost the quality of the backlight module.

### BACKGROUND OF THE INVENTION

1. Field of the Invention

The present invention relates to a display technique, more particularly, to a backlight module and a liquid crystal display (LCD) device.

2. Description of the Prior Art

A conventional liquid crystal display (LCD) device includes a backlight module, a LCD panel and a front frame. The backlight module includes a LED, a light guide plate, an optical film, a plastic frame and a bezel. With the increasing performance of a LED, the number of the LEDs decreases gradually to save cost. Under the circumstance, the distance between the LEDs is going to increase.

In addition, the LEDs on a light bar do not emit continuously because the LED is a point light source. Therefore, it is difficult to mix light evenly within an effective light mixing distance, i.e. the distance from the LED to a viewing area of a backlight module. Furthermore, with the development of LED backlight, it has to narrow down the light mixing distance of a LED to achieve a purpose of a slim plastic frame.

Such being the case, no matter that the distance between LEDs increases or the light mixing distance decreases, it attributes to a mura defect in the backlight module.

Besides, to ensure the thin optical film pressed by the plastic frame escaping from the backlight module, the optical film usually extends tea an edge of the light guide plate. It leads to the light from the LED incident into the optical film directly and then leaking from the opening of the backlight module.

Therefore, it is necessary to provide a backlight module and a LCD device.

### SUMMARY OF THE INVENTION

The object of the present invention is to provide a backlight module and a LCD device to resolve a mura problem of the incident side of a backlight module.

According to the present invention, a backlight module, composes: a light guide plate comprising an incident surface and an emitting surface connecting with the incident surface; a light bar disposed near the incident surface, a plurality of LEDs disposed on a side of the light bar close to the incident surface at intervals; an optical film disposed on the emitting surface, a plurality of notches formed on a side of the optical film close to the light bar, each of the notches lilting One of the plurality of the LEDs, a profile of each notch being rectangular, arc or triangle; a plastic frame comprising a body component, an extension component extended from the body component over the emitting surface, and a shading component extended from a bottom of the extension component and towards the notches, the side of the optical film close to the light bar located between the extension component and the emitting surface, and an end surface of the shading component away from the extension component contacting the emitting surface of the light guide plate.

In one aspect of the present invention, the optical film is as diffuser, a prism or to dual brightness enhancement film (DBEF) and has the plurality of notches formed by cutting, the optical film.

In another aspect of the present invention, the side edge of the optical film is at the same level with an intersection of the emitting surface and the incident surface, and the profile of the end surface of the shading component fits to that of the notches.

According to the present, as backlight module comprises: as light guide plate comprising an incident surface and an emitting surface connecting with the incident surface; a light bar disposed near the incident surface, a plurality of LEDs disposed on a side of the light bar close to the incident surface at intervals; and an optical film disposed on the emitting surface, a plurality of notches formed on a side of the optical film close to the light bar. Each of the notches fining one of the plurality of the LEDs.

In one aspect of the present invention, a profile of each notch is rectangular, arc or triangle.

In another aspect of the present invention, the optical film is a diffuser, a prism or a dual brightness enhancement film (DBEF) and has the plurality of notches formed by cutting the optical film.

In still another aspect of the present invention, the backlight module further comprises a plastic frame. The plastic frame comprises a body component, an extension component extended from the body component over the emitting surface, and a shading component extended from a bottom of the extension component and towards the notches. The side of the optical film close to the light bar is located between the extension component and the emitting surface. An end surface of the shading component away from the extension component contacts the emitting surface of the light guide plate.

In yet another aspect of the present invention, the side edge of the optical film is at the same level with an intersection of the emitting surface and the incident surface, and the profile of the end surface of the shading component fits to that of the notches.

According to the present invention, an LCD device comprises: a bezel; a light guide plate disposed on the bezel, comprising a incident surface and a emitting surface connecting with the incident surface; a light bar disposed near the incident surface, a plurality of LEDs disposed on a side of the light bar close to the incident surface at intervals; an optical film on the emitting surface, having a plurality of notches at a side close to the light bar, and each of the plurality of notches fitting one of the plurality of LCD light sources; a plastic frame comprising a body component and an extension component extended from the body component over the emitting surface, and the side of the optical film close to the light bar located between the extension component and the emitting surface; a liquid crystal panel on the plastic frame; a front frame assembling with the bezel to fix the liquid crystal panel between the front frame and the plastic frame.

In one aspect of the present invention, a profile of each notches is rectangular, arc or triangle.

In another aspect of the present invention, the optical film is diffuser, prism or DBEF and has the plurality of notches formed by cutting the optical film.

In still another aspect of the present invention, the plastic frame further comprises a shading component extended from the bottom of the extension component to the direction of the notch, and the end surface of the shading component contacts the emitting surface of the light guide plate.

In yet another aspect of the present invention, the side edge of the optical film is at the same level with an intersection of the emitting surface and the incident surface, and the shape of the end surface of the shading component corresponds to that of the notches.

The advantages of the present invention is that it prevents an optical film from light-gathering the area in front of the LED by using the optical film in the shape or the arrangement of the LED. The correspondent shape of the optical film is notch. In addition, it also increases brightness to improve a mura problem of the incident side of the backlight module by focusing light of the optical film in the darker area of the two adjacent LEDs.

Furthermore, the light emitted from the LED to the correspondent notch of the optical shaded by a shading component of a plastic frame to avoid light from the LED injecting into the optical film directly. In hence, it reduces the risk of light leakage of the backlight module. Therefore, it improves light leakage of the backlight module in a design of a narrow plastic frame to increase display quality of the backlight module and the LCD panel.

### BRIEF DESCRIPTION OF THE DRAWINGS

FIG. 1 is a section structure diagram of a backlight module in the present invention.

FIG. 2 shows a schematic diagram of the optical film and the light bar in the present invention.

FIG. 3 is a diagram of the optical film according to a first embodiment of the present invention.

FIG. 4 is a diagram of the optical film according to a second embodiment of the present invention.

FIG. 5 is a diagram of the optical film according to a third embodiment of the present Invention.

FIG. 6 is a structure diagram of the LCD device according to the present invention.

### DETAILED DESCRIPTION OF THE PREFERRED EMBODIMENTS

These and other features, aspects and advantages of the present disclosure will become understood with reference to the following description, appended claims and accompanying figures.

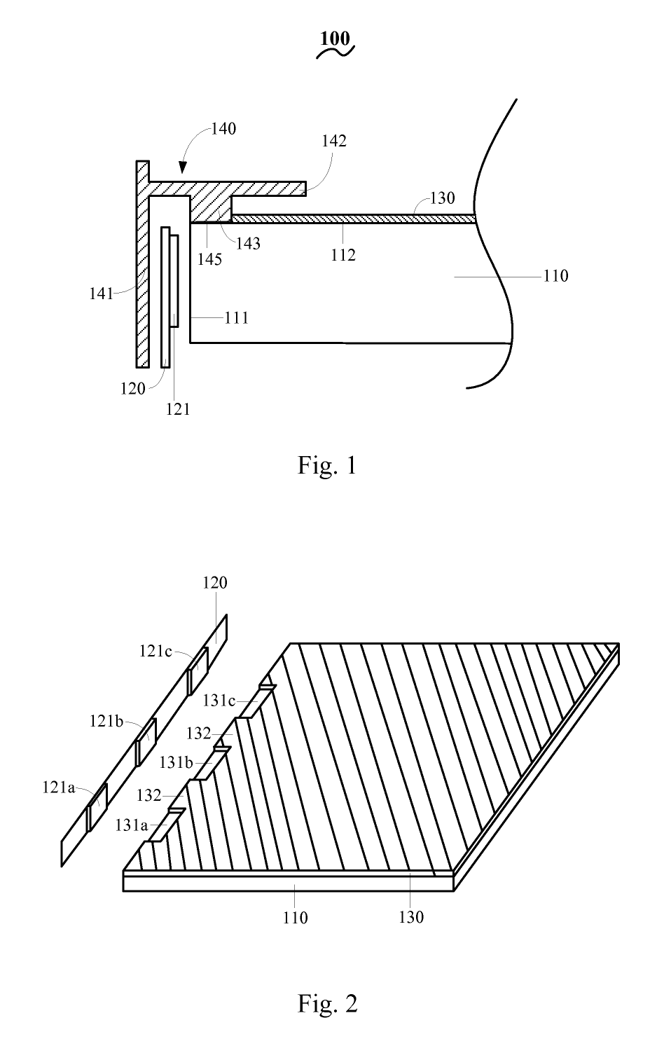

FIG. 1 is a section structure diagram of a backlight module in the present invention. As FIG. 1 Shows, a backlight module 100 comprises a light guide plate 110, a light bar 120, an optical film 130 and a plastic frame 140.

The light guide plate 110 comprises an incident surface 111 and an emitting surface ILL connecting with the incident surface 111. The light bar 120 is disposed at one side of the incident surface 111. A plurality of LEDs 121 on the light bar 120 facing to the incident surface 111 are set up at intervals. The optical film 130 is set up on the emitting surface 112.

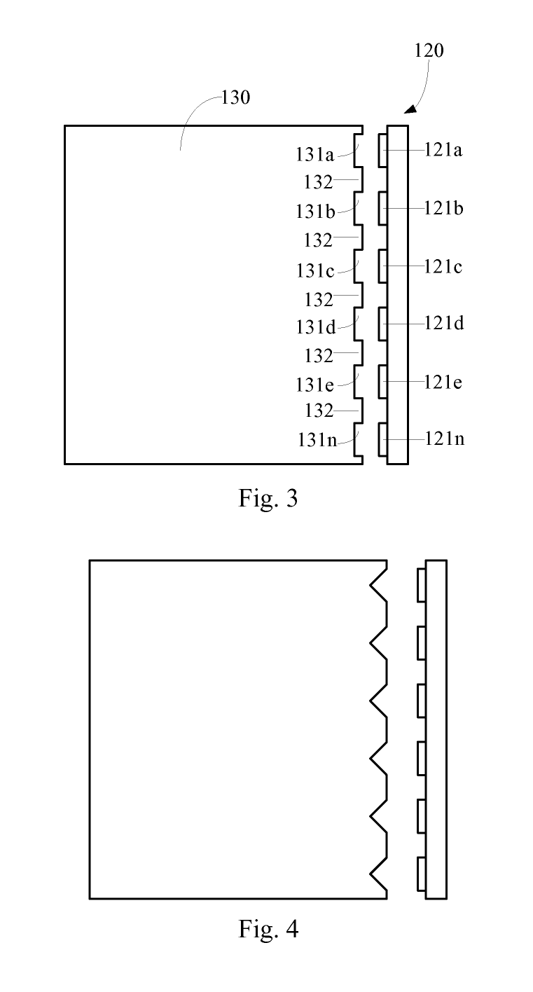

FIG. 2 shows a schematic diagram of the optical film 130 and the light bar 120 in the present invention. FIG. 3 is a diagram of the optical film 130 according to a first embodiment of the present invention.

Please referring to FIG. 2 in conjunction to FIG. 3, notches 131a, 131b, 131c, 131d, 131e . . . , 131n are formed on an edge of the optical film 130, which is close to the light bar 120, Each notch fits one of the plurality of the LED. Specifically, the notch 131a fits a LED 121a, the notch 131b fits a LED 121b, the notch 131c fits a LED 121c, the notch 131d fits a LED 121d, the notch 131e fits a LED 121e and the notch 131n fits a LED 121n. The optical film 130 has a plurality of bulges 132. Each bulge 132 is between the two adjacent notches, i.e. each bulge 132 fits an area between two adjacent LEDs 121.

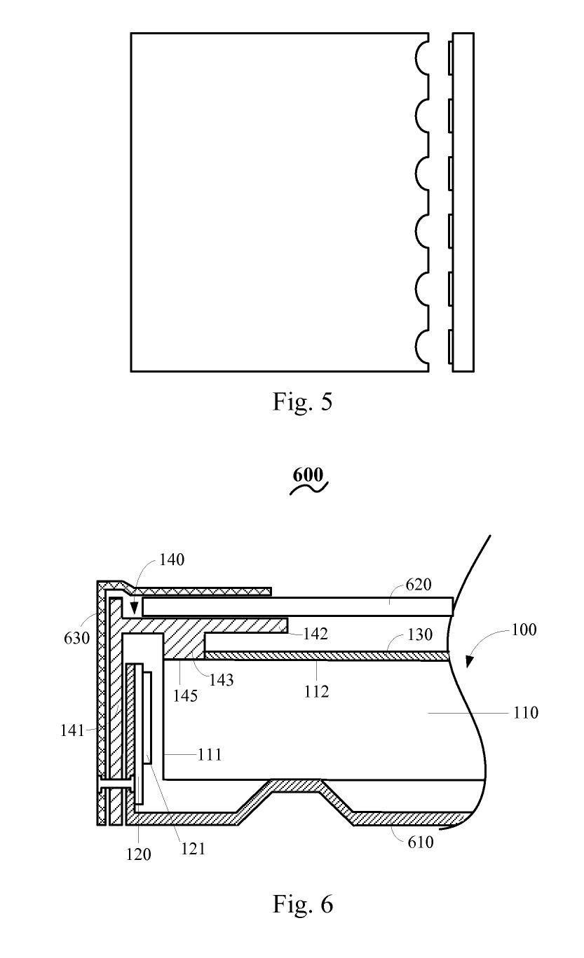

In this embodiment, a profile of each of notches 131a, 131b, 131c, 131d, 131e, . . . , 131n is rectangular. In another embodiments, the profile of each of notches 131a, 131b, 131c, 131d, 131e . . . 131n can be arc (shown in FIG. 4) or triangle (shown in FIG. 5).

The optical film 130 in the embodiment, such as diffuser, prism, or dual brightness enhancement film is used for enhancing brightness or uniformity of the emitted light from a backlight module. The diffuser made of a material with higher light transmittance is mainly provided to generate an even surface light source. The prism is a light-gathering device and mainly used for emitting the light after being focused at a certain angle to enhance the brightness in the area at the certain angle according to Law of total reflection and refraction. The DBEF is also a light-gathering device and used for enhancing the brightness of emitting surface of the backlight module.

Please refer to FIG. 1 again. The plastic frame in the embodiment comprises a body component 141, an extension component 142 and a shading component 143. The body component 141 is spaced apart the incident surface 111. The extension component 142 extends from the body component 141 over the incident surface 112, and the shading component 143 extends from a bottom of the extension component 142 and toward the optical film 130. More specifically, the side of the optical min 130 whose notches is located between the extension component 142 and the emitting component 112. The shading component 143 extends to the notches in the optical film 130, and the end surface 130 of the shading component 143 away from the extension component 142 contacts the emitting surface 112 of the light guide plate 110. The side edge of the optical film 130 is at the same level with an intersection of the emitting surface 112 and the incident surface 111 as FIG. 2 shows. The shape of the end surface 145 of the shading component 143 fits to the shape of the notches 131a, 131b, 131c, 131d, 131e . . . 131n.

Material of the shading component 143 has high light absorption or low light reflectivity, like plastic, polyethylene terephthalate resin, silicon or micro hole polymer, etc. The shading component 143 and the body component 141 can be integrally molded in injection or other appropriate ways.

Since a region in front of the LED 121 of the light bar 120 is brighter than a region between two adjacent LEDs 121, a notch on the optical film 130 is in front of the LED 121 to prevent the optical film 130 from light-gathering the region. On the other hand, the region between the two adjacent LEDs 121 is darker, the bulge 132 of the optical film 130 corresponding to the darker area between the two adjacent LEDs 121 focuses light to enhance the brightness so that it reduces a brightness difference of the incident surface 111 to improve the mura of the incident surface 112.

Because the shape of the end surface 145 in the shading component 143 fits that of the notches 131a, 131b, 131c, 131d, 131e . . . 131n, and the end surface 145 extends to the emitting surface 112 contacted with the light guide plate 110, it is capable of shading the light from the LED 121 to the correspondent notches to prevent the light from the LED 121 from emitting into the optical film 130 directly. Therefore, it reduces the risk of light leakage of the incident surface 111.

FIG. 6 is a structure diagram of the LCD device according to the present invention. As FIG. 6 Shows, a LCD device 600 taking the backlight module 100 mentioned above as a backlight source further comprises a bezel 610, a liquid crystal panel 620 and a front frame 630.

The light guide plate 110 is arranged on the bezel 610, and the liquid crystal panel 620 is set up on the top surface of the extension component 142 at the plastic frame 140. The front frame 630 and the bezel 610 are assembled to firmly fix the liquid crystal panel 620 between the front frame 630 and the plastic frame 644. The front frame 630 and the bezel 610 are fixed by a screw lock or a buckle structure.

As the above mention, the extended length of the optical film 130 under the plastic frame 140 is limited to effectively prevent the optical film 130 slipping out from the backlight module 100 because not only the side edge of the optical film 130 extends at the same level to an intersection of the emitting surface 112 and the incident surface 111 but also the bulges 132 of the optical film 130 press the area between the extension component 142 of the plastic frame 140 and the emitting surface 112 in the light guide plate 110 while being assembled.

In conclusion, the present invention prevents an optical film from light-gathering the area in front of the LED by using the optical film in the shape of the arrangement of the LED. The shape of the optical film correspondent to the brighter area in front of the LED is notch. In addition, it also increases brightness to improve a mura problem of the incident side of the backlight module by focusing light of the optical film in the darker area of the two adjacent LEDs.

Furthermore, the light emitted from the LED to the correspondent notch of the optical film is shaded by a shading component of a plastic frame to avoid light from the LED injecting into the optical film directly. In hence, it reduces the risk of light leakage of the backlight module. Therefore, it improves light leakage backlight in a design of a narrow plastic frame to increase display quality of the backlight module and the LCD panel.

As required, a detailed illustrative embodiment of the present invention is disclosed herein. However, techniques, systems and operating structures in accordance with the present invention. may he embodied in a wide variety of forms and modes, some of which may be quite different from those in the disclosed embodiment. Consequently, the specific structural and functional details disclosed herein are merely representative, yet in that regard, they are deemed to afford the best. embodiment for purposes of disclosure and to provide a basis for the claims herein, which define the scope of the present invention.

What is claimed is:

1. A backlight module, comprising:
a light guide plate comprising an incident surface and an emitting surface connecting with the incident surface;
a light bar disposed near the incident surface, a plurality of LEDs disposed on a side of the light bar close to the incident surface at intervals;
an optical film disposed on the emitting surface, a plurality of notches formed on a side of the optical film close to the light bar, each of the notches fitting one of the plurality of the LEDs, a profile of each mitotic being rectangular, arc or triangle;
a plastic frame comprising a body component, an extension component extended from the body component over the emitting surface, and a shading component extended from a bottom of the extension component and towards the notches, the side of the optical film close to the light bar located between the extension component and the emitting surface, and an end surface of the shading, component away from the extension component contacting the emitting surface of the light guide plate.

2. The backlight module of claim 1, wherein the optical film is a diffuser, a prism or a dual brightness enhancement film (DBEF) and has the plurality of notches formed by cutting the optical film.

3. The backlight module of claim 1, wherein the side edge of the optical film is at the same level with an intersection of the emitting surface and the incident surface, and the profile of the end surface of the shading component fits to that of the notches.

4. A backlight module, comprising:
a light guide plate comprising an incident surface and an emitting surface connecting, with the incident surface;
a light bar disposed near the incident surface, a plurality of LEDs disposed on a side of the light bar close to the incident surface at intervals: and
an optical film disposed on the emitting surface, a plurality of notches formed on a side of the optical film close to the light bar,
wherein each of the notches fitting one of the plurality of the LEDs.

5. The backlight module of claim 4, wherein a profile of each notch is rectangular, arc or triangle.

6. The backlight module of claim 4, wherein the optical film is a diffuser, a prism or a dual brightness enhancement film (DBEF) and has the plurality of notches formed by cutting the optical film.

7. The backlight module of claim 4 further comprising a plastic frame, wherein the plastic frame comprises a body component, an extension component extended from the body component over the emitting surface, and a shading component extended from a bottom of the extension component and towards the notches, the side of the optical film close to the light bar is located between the extension component and the emitting surface and an end surface of the shading component away from the extension component contacts the emitting surface of the light guide plate.

8. The backlight module of claim 7, wherein the side edge of the optical film is at the same level with an intersection of the emitting surface and the incident surface, and the profile of the cud surface of the shading component fits to that of the notches.

9. An LCD device, comprising:
a bezel:
a light guide plate disposed on the bezel, comprising a incident surface and a emitting surface connecting with the incident surface;
a light bar disposed near the incident surface, a plurality of LEDs disposed on a side of the light bar close to the incident surface at intervals;
an optical film on the emitting surface, having a plurality of notches at a side close to the light bar, and each of the plurality of notches fitting one of the plurality of LCD light sources;
a plastic frame comprising a body component and an extension component extended from the body component over the emitting surface, and the side of the optical film close to the light bar located between the extension component and the emitting surface;
a liquid crystal panel on the plastic frame;
a front frame assembling with the bezel to fix the liquid crystal panel between the front frame and the plastic frame.

10. The LCD device of claim 9, wherein a profile of each notch is rectangular, arc or triangle.

11. The LCD device of claim 9, wherein the optical film is diffuser, prism or DBEF and has the plurality of notches formed by cutting the optical film.

12. The LCD device of claim 9, wherein the plastic frame further comprises a shading component extended from the bottom of the extension component to the direction of the notch, and the end surface of the shading component contacts the emitting surface of the light guide plate.

13. The LCD device of claim 7, wherein the side edge of the optical film is at the same level with an intersection of the emitting surface and the incident surface, and the shape of the end surface of the shading component corresponds to that of the notches.
